(19) United States
(12) Patent Application Publication
(10) Pub. No.: US 2022/0236754 A1
(43) Pub. Date: Jul. 28, 2022

(54) POWER MANAGEMENT SYSTEM

(71) Applicant: Kimberly-Clark Worldwide, Inc., Neenah, WI (US)

(72) Inventor: James Dinh, Norcross, GA (US)

(21) Appl. No.: 17/614,912

(22) PCT Filed: May 31, 2019
(86) PCT No.: PCT/US19/34802

§ 371 Date: Nov. 29, 2021

(51) Int. Cl. G05F 1/46; G05F 1/575; G06F 1/28

(52) U.S. Cl. CPC G05F 1/462; G06F 1/28; G05F 1/575

(57) ABSTRACT

The present invention relates to a power management system and a controlling method thereof. The disclosed power management system comprises a power supply device configured to provide input voltages to a load, a power state indicator device configured to store data specifying two or more power states for the load including a current state defining a current power state of the load and a load next state defining a predicted, next-in-time, power state of the load, and a power supply control device configured to independently vary the input and output voltages based on a change from the load current state to the load next state. A predictive signal is used to control the change of input voltage. The disclosed power management system is used to smooth the variation of output voltages when it is ready to change from idle/sleep power states to full power/active states or vice versa.

### BACKGROUND OF THE DISCLOSURE

Electronic apparatuses such as smartphones, tablet computers and dispenser devices, for example, are typically equipped with multiple functions and features. In general, multiple power sources are provided in an electronic apparatus to power the multiple functions and features, and these multiple functions and features are typically controlled individually regarding their respective power supply and usage.

Dynamic voltage and frequency scaling (DVFS), a power management system technique, is typically employed in electronic apparatuses for system power saving. In conventional approaches, runtime software for DVFS may be utilized to adjust the voltage and/or frequency, or clock rate, according to system requirement of the electronic apparatus. However, the software needs to synchronize with current system requirements for voltage and clock rate according to scenario usage in order to determine whether voltage scaling and/or frequency scaling (or clock rate adjustment) would be required.

Accordingly, current power management systems use reactive signals from multiple sensors and sub-systems to make a change in output voltages to reduce current power loss or to change switch frequency in order to reduce the number of cycles used to generate power.

However, there exists a continued need to achieve and maximize overall power management system efficiency. The current invention addresses this need by utilizing an improved apparatus and method for maximizing power management system efficiency and power savings through regulating input voltages supplied to integrated circuit devices such as a central processing units (CPU's) that exhibit large abrupt changes in current demand.

### SUMMARY OF THE DISCLOSURE

Lower power consumption and higher efficiency results in improved performance and lower power lower costs of an electronic apparatus particularly for use in a dispensing device. The current disclosure addresses this need by regulating input voltages and frequencies by using predictive signal from a processing device.

In one embodiment, the present invention is directed to a power management system that comprises a power supply device configured to provide a first input voltage and a second input voltage. The power management system also comprises at least one voltage regulator configured to receive the first and second input voltages. The power management system additionally provides a first output voltage, based on the first input voltage that is connected to a first load, and a second output voltage, based on the second input voltage that is connected to a second load. The power management system also provides for a power state indicator device configured to store data. The data stored specifies two or more power states for the first load including a first load current state defining a current power state of the first load and a first load next state defining a predicted, next-in-time, power state of the first load. The data stored also specifies two or more states for the second load including a second load current state defining a current power state of the second load and a second load next state defining a predicted, next-in-time, power state of the second load. The power management system also comprises a power supply control device configured to independently vary (i) the first input and first output voltages based on a change from the first load current state to the first load next state and (ii) the second input and second output voltages based on a change from the second load current state to the second load next state.

In another embodiment, the present invention is directed to a method of controlling an input voltage provided to a processing device that includes multiple processing pipelines by a voltage regulator. The method comprises receiving, by the voltage regulator, a feedback enable or disable signal for controlling the input voltage of the voltage regulator. The method also comprises receiving a load control signal indicating an anticipated change in load current required by the device. The method additionally comprises directly controlling a driver circuit of the voltage regulator used to generate the input voltage based on the load control signal by modifying the feedback error signal to provide an anticipatory change in the voltage to the device. As a result, an absolute minimum voltage level is shifted up in anticipation of an increased load on the processing pipelines and an absolute maximum voltage level is shifted down in anticipation of an unloading of one or more of the multiple processing pipelines. By following the aforementioned, a total deviation of the input voltage from a nominal output voltage is minimized.

### BRIEF DESCRIPTION OF DRAWINGS

FIG. 1 is a block diagram of an example power management system in accordance with an implementation of the present disclosure.

FIG. 2 illustrates an exemplary computer subsystem with a voltage regulator providing a supply voltage to a central processing unit (CPU) in accordance with embodiments of the present invention.

FIG. 3 illustrates an exemplary current load induced transient voltage response of the voltage regulator of FIG. 2 utilizing a load line feature of a voltage regulator in accordance with embodiments of the present invention.

FIG. 4 is a flowchart of exemplary operations for controlling a voltage regulator in accordance with one embodiment of the present invention.

FIG. 5 illustrates an exemplary circuit arrangement for controlling a voltage regulator by artificially adjusting a feedback voltage based on a load control signal.

FIG. 6 illustrates an exemplary circuit arrangement for controlling a voltage regulator by artificially adjusting a feedback current based on a load control signal.

FIG. 7 illustrates an example of variation in loading state of a circuit section over time.

### DEFINITIONS

When introducing elements of the present disclosure or the preferred embodiment(s) thereof, the articles “a”, “an”, and “the” are intended to mean that there are one or more of the elements.

The terms “comprising”, “including” and “having” are intended to be inclusive and mean that there may be additional elements other than the listed elements.

The term “electronic apparatus” refers to computer and electrical equipment including smartphones, tablet computers, dispenser devices and the like.

The term “dispenser device” refers to an automatic machine or container which is designed to release an amount of soap, paper-towels, toothpaste, candy, pills, hearing aids, cash, vending machine, labels or the like.

The term “power management system” refers to electric power being efficiently delivered through an electronic apparatus.

The term “predictive signal” refers to a signal from a central processing unit or memory processing unit to indicate to other subsystems that a power management system is ready to change from idle/sleep power states to full power/active states or vice versa.

The term “reactive signal” refers to a signal from a central processing unit or memory processing unit to indicate to other subsystems that a power management system has already changed from idle/sleep power state to full power/active state or vice versa.

### DETAILED DESCRIPTION

The present invention relates generally to power management in an electronic apparatus. More particularly, the present invention relates to power management techniques using input voltages to drive central processor unit (CPU) activity and memory control unit (MCU)/memory processing unit (MPU) activity within the electronic apparatus.

Embodiments of the present invention provide a mechanism allowing a regulator(s) to adjust its input voltage in anticipation of a change in load. The regulator(s) provides a supply voltage to a device which, therefore, represents a load driven by the regulator(s). The electronic apparatus, in turn, provides a load signal in anticipation of a change in load (e.g., caused by the utilization of a greater or lesser number of components on the apparatus). In other words, the load signal may provide an “early warning signal” of sorts, causing the regulator(s) to adjust the supply voltage provided to the device to minimize the impact of transient voltage spikes caused by the change in load. As a result, the effective transient voltage response of the regulator(s) may be improved, while the size and cost of components in the regulator circuitry (e.g., load capacitors) may be reduced.

As a specific, but not limiting example, one embodiment of the present invention provides a central processing unit (CPU) that adjusts a load signal in anticipation of a change in load, for example, based on an expected change in utilization of a number of parallel processing pipelines. However, those skilled in the art will recognize that the concepts described herein may be used to similar advantage in a variety of different devices, such as central processing units (CPUs) digital signal processors (DSPs), and the like, to reduce the impact of voltage transients caused by abrupt changes in load.

### An Exemplary Power Management System

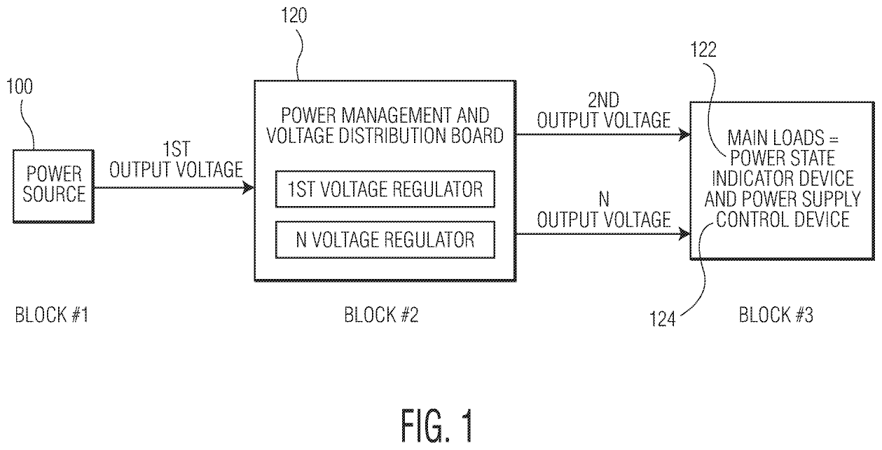

For exemplary purposes, FIG. 1 illustrates a block diagram of an example power management system in accordance with an implementation of the present disclosure. Specifically, FIG. 1 shows a power source supply device 100 that is configured to provide for a first input voltage and a second input voltage. The voltages will be generated from either an AC power source or a DC power source. If the voltage is generated from an AC source, a transformer/magnetic will convert AC voltages to DC voltages, and step down to DC system required voltages. Or alternatively, if the voltage is generated from an AC source, an AC/AC voltage system distribution may be used. If the voltage is generated from a DC source, the voltage will convert thru a DC/DC regulator to DC system required voltages.

A voltage regulator 120 receives the first and second input voltages and provides for a first and a second output voltages that is based on the first and second input voltage to a first and second load, respectively.

For illustrative purposes, a DC/DC regulator is used in the voltage regulator processes as a first and second power regulators in block number 2 of FIG. 1. A DC/AC regulator or AC/AC regulator may be used as a voltage regulator herein as well. The choice of voltage regulator utilized herein is dependent on what voltage is initially utilized in the power supply device 100.

Regulated DC/DC voltage regulators generally provide for regulated power to operational circuitry, for example integrated circuits in semiconductor devices used in a wide variety of applications. Integrated circuits generally require provision of power within particular parameters during operation. The provision of such power may face many complexities. For example, semiconductor chips including the integrated circuits may have different portions that require power at the same or different times, different portions may require power within different parameters, and some portions may utilize different amounts of power at different times. Complicating matters, some devices may be powered by batteries having relatively small capacities, while the electronic apparatus' themselves, at least at various times, may require large amounts of power.

In view of block number 2 in FIG. 1, there is at least one voltage regulator. The N power number of voltage regulators depicted in FIG. 1 demonstrates the use of additional regulator(s) that may be implemented. In other words, one additional voltage regulator to about twenty additional voltage regulators may be used for example.

The output voltages are then maintained in a main load which encompasses a power state indicator device 122 and a power supply control device 124. Please see block number 3 in FIG. 1. For illustrative purposes, there are two output voltages entering block number 3. Of course, there could be one or more output voltages entering block number 3 from block number 2 as the number of output voltages are determined by the number of regulators in block number 2. Accordingly, the number of loads in block number 3 are dependent on the number of output voltages that enter block number 3 from block number 2. In FIG. 1, two output voltages entering block number 3 are shown. Therefore, there two loads for block number 3.

The power state indicator device 122 is configured to store data specifying two or more power states for the first load including a first load current state defining a current power state of the first load. The power state indicator device 122 is also configured to store data from the first load next state defining a predicted, next-in-time, power state of the first load. The power state indicator device 122 also is configured to store data from the two or more states for the second load including a second load current state defining a current power state of the second load and a second load next state defining a predicted, next-in-time, power state of the second load.

Block number 3 in FIG. 1 also depicts a power supply control device 124. The power supply control device 124 is configured to independently vary the first input and first output voltages based on a change from the first load current state to the first load next state. The power supply control device 124 is also configured to independently vary the second input and second output voltages based on a change from the second load current state to the second load next state. Each power supply control device 124 has its own power controller, normally called Pulse Width Modulator “PWM”. This PWM will independently monitor, control, and vary the duty cycles according to the load changes and as a result, the output or input voltages of each power supply control device will be varied according to its load changes.

### Input and Output Voltages

Varying voltages supplied to operating circuits and/or varying a clock rate which govern timing of operations of the operating circuits may assist in reducing power consumption by the operating circuits. This may be performed dynamically during circuit operations, and may be based on amount of workload, nature of workload, as well as operating circuit temperature information, for example from process, variation, and temperature sensors, and information relating to whether circuit operation should be optimized for performance or efficiency. Unfortunately, such dynamic voltage and frequency scaling operations may not sufficiently provide for a combination of desired circuit operation and power consumption control under varying operating conditions. It is important to note that the clock rates for the internal voltages change at different loads. Specifically, the clock rates change depending on the use of the device, i.e. low, medium, or high traffic.

Moreover, today's electronic apparatus' are designed and powered by fixed voltage distribution rails regardless of the load. This fixed voltage distribution may not give the power management system the best energy efficiency at a light or idle load. The current disclosure solves this concern. The electronic apparatus or dispenser device will be operated at high voltage distribution when active and will operate at low voltage distribution when light or idle. Accordingly, at maximum load, a high input voltage will be placed through a current thus rendering the current low and power consumption less. At minimum loads or when the system is idle, a low input voltage is required so the power consumption is less due to Power=Frequency×Voltage. In other words, a high input voltage and high frequency will produce more power.

Furthermore, in accordance with FIG. 1, for example, as long as the overall power management system is running (without switching off), input voltages may power the system at any voltage. Preferably the voltage may be between 1 and 20 volts and more preferably the voltage may be between 4 and 8 volts.

In general, voltages may utilize a number of high speed processing pipelines operating in parallel. When several of these pipelines are loaded up for processing, after being idle, the resultant load increase may cause current demand several times greater than what is demanded when the pipelines are not as heavily loaded. With several hundred million transistors in the pipelines, the increase in current may be well over 100 percent. In conventional systems, such an abrupt change in load may result in transient voltage spikes that might cause operational failures if the supply voltage levels fall outside operational limits. In addition, voltage overshoots caused when current demand is abruptly reduced may lead to reduced reliability.

### An Exemplary Subsystem of Controlling Input Voltage of the Power Management System

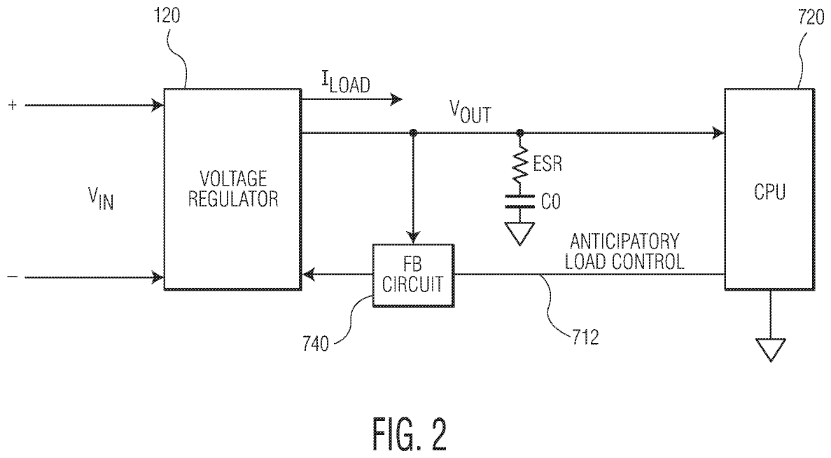

FIG. 2 illustrates an exemplary voltage regulator 120 that provides a supply voltage (V_{IN}) to a central processing unit (CPU) 720 that generates an anticipatory load signal 712. As illustrated, for some embodiments, the load signal 712 may be used to control feedback circuitry 740 that generates a feedback signal monitored by the voltage regulator 120 and used to adjust the voltage regulator input power to maintain a desired input voltage V_{IN}.

The CPU 720 may utilize a number of high speed processing pipelines operating in parallel. When several of these pipelines are loaded up for processing, after being idle, the resultant load increase may cause current demand several times greater than what is demanded when the pipelines are not as heavily loaded. With several hundred million transistors in the pipelines, the increase in current may be well over 100 percent. In conventional systems, unlike the current invention, such an abrupt change in load may result in transient voltage spikes that might cause operational failures if the supply voltage levels fall outside operational limits. In addition, voltage overshoots caused when current demand is abruptly reduced may lead to reduced reliability.

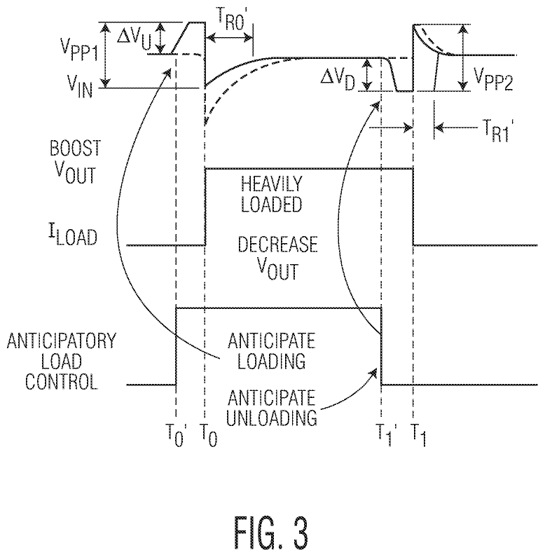

By generating the load signal in anticipation of such a change in load, the CPU 720 may provide an early warning signal of sorts, causing the voltage regulator 120 to adjust the supply voltage to compensate. For example, as illustrated in FIG. 3, at time T0′, prior to an expected sudden increase in current when the CPU pipelines are heavily loaded (at time T0), the load signal may cause V_{IN} to be adjusted upward (by DELTAV_{U}). As a result, when the load current increases, at time T0, the transient dip in voltage does cause the voltage to drop as low as it would have without the shift up. The anticipatory increase in voltage may result in additional current being available from the input resistor, allowing it to better handle the increase in load. Similarly, prior to unloading the pipelines, at time T1′, the load signal may be changed, causing V_{IN} to be adjusted downward (by DELTAV_{D}). As a result, when the load current decreases, at time T1, the transient increase in voltage is not as great as it would have been absent the anticipatory shift down in the regulator input voltage.

For comparison, in FIG. 3 the transient swings in supply voltage signal without the anticipatory shifts before loading and unloading, are shown as dashed lines. In some cases, the peak-to-peak magnitude of the transients may be the same with and without use of the load signal. However, the absolute minimum voltage level reached is shifted up by increasing the supply voltage in anticipation of the loading, while the absolute maximum voltage level reached is shifted down by decreasing the supply voltage in anticipation of the unloading. In addition to providing a safety margin from the minimum and maximum values, by decreasing the total deviation from the nominal operating voltage, the response times required to recover from the loading and unloading (TR0′ and TR1′, respectively) are decreased. While this technique works with regulators that utilize load line (or droop) functionality, other regulators may utilize different circuitry responsive to a load signal. Further, even if the load signal is generated with little or no advanced warning relative to an increase in demand current, the load signal may result in faster regulator response time than the output voltage propagating through all the capacitors. In some cases, the load signal could even come after a load change and there may still be an advantage in quicker regulator response time.

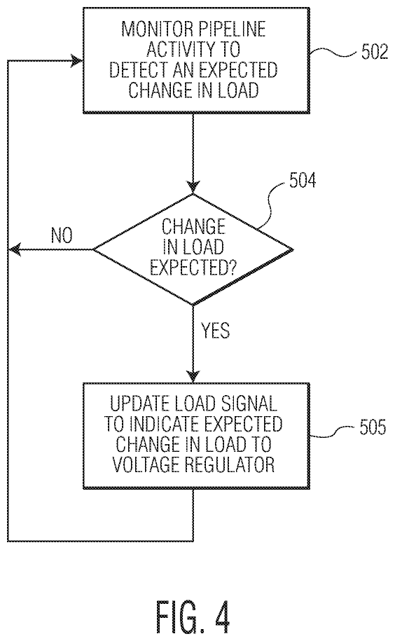

FIG. 4 is a flowchart of exemplary operations for controlling a voltage regulator in accordance with one embodiment of the present invention. For example, these operations may be performed, for example, by the CPU 720 in order to adjust the load signal 312 to provide an early warning to the voltage regulator 120 of expected changes in load current. For some embodiments, an external device, such as a CPU that sends instructions or data, may detect an anticipated change in load current demanded and may generate the load control signal.

The operations begin, at step 502, by detecting an expected change in load current. As an example, the CPU 720 may monitor a number of idle cycles for a sample set of pipelines as an indication that the pipelines are being loaded. As another example, a set of instructions, executed by the CPU may contain markers that provide an indication to the CPU that heavy pipeline activity, or a reduction in pipeline activity, is likely.

In any case, if a change in load is not expected, as determined at step 504, the operations are repeated without adjusting the load signal. On the other hand, if a change of load is expected, the load signal is adjusted, at step 506, thereby causing a corresponding anticipatory change in the voltage supplied by the voltage regulator 120. The load signal may be a single bit (e.g., driven on a singly output pin) or multiple bits. A single bit output signal will allow a device to indicate more or less current is to be required. Multiple bits, on the other hand, may allow quantification of the additional current expected (e.g., 25 percent, 50 percent, etc.), allowing the anticipatory increases or decreases in voltage supplied by the regulator to be adjusted accordingly.

### Exemplary Mechanisms for Adjusting Input Voltage Based on a Load Signal

For some embodiments, feedback circuitry internal to the regulator(s) may be configured to allow adjustment of a feedback signal provided to the regulator(s) in response to a change in an anticipatory load signal provided by a processing device. The exact circuitry may vary depending on the exact type of feedback signal utilized by the regulator(s).

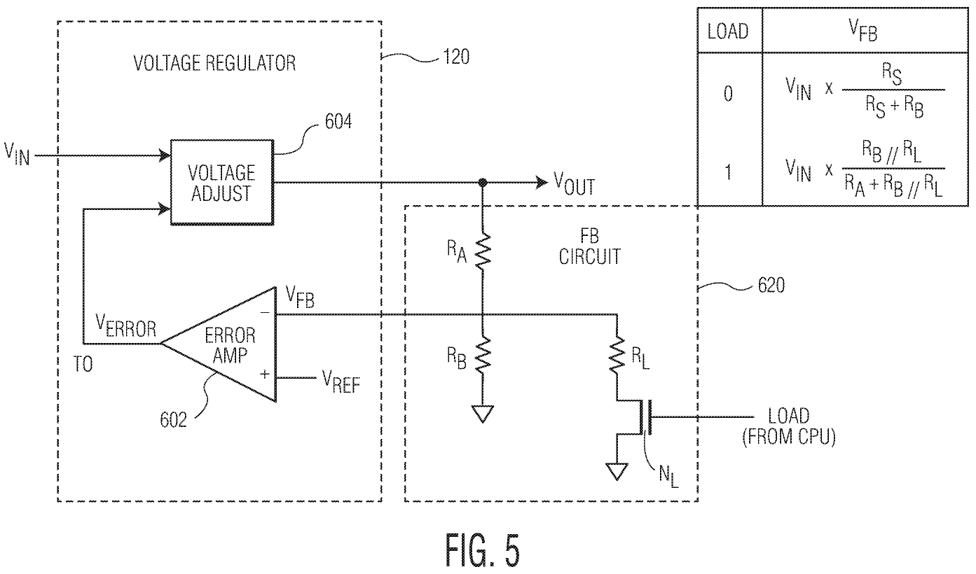

As an example, FIG. 5 illustrates a feedback circuit 620 configured to vary a feedback voltage (V_{FB}) provided to a voltage regulator 120. As illustrated, the load signal is used to switch a transistor NL in order to vary the resistance of a voltage divider circuit (formed by R_{A}, R_{B}, and R_{L}, depending on the load signal) used to generate the feedback voltage. When the load signal is not asserted (logic low or ‘0’), the transistor NL is switched off and the feedback voltage is defined by the following equation based on the voltage divider:

V_{FB}=V_{IN}SS[R_{B}/(R_{A}+R_{B})]

Once the load signal is asserted (logic high or ‘1’), indicating an expected increase in current demand, the transistor NL is switched on and the bottom portion of the voltage divider network becomes R_{L} in parallel with R_{B}(R_{B}?R_{L}). As a result, the feedback voltage is defined by the following equation based on the voltage divider:

V_{FB}=V_{IN}SS[R_{B}?R_{L}/(R_{A}+R_{B}?R_{L})]

Because the parallel combination of R_{B} and R_{L} is less than R_{B} alone, the feedback voltage is reduced which should cause the voltage regulator 120 to increase its input and raise V_{IN}. As illustrated, the voltage regulator 120 may include an error amplifier 602 that generates an offset or “error” voltage V_{ERROR} indicating a difference between the feedback voltage and a reference voltage. The error voltage may be fed back to a voltage adjust circuit 604 that increases the input voltage if the feedback voltage is less than the reference or decreases the input voltage if the feedback voltage is greater than the reference voltage.

For embodiments where a multi-bit load signal is generated, multiple load resistors may be selectively placed in parallel to incrementally adjust the feedback voltage, as necessary. For some embodiments, the load signal may be used to adjust the reference voltage in a similar manner, which may have a similar effect. For example, increasing V_{REF} when the load signal is asserted would also result in an increase in V_{ERROR} and a corresponding increase in V_{IN}.

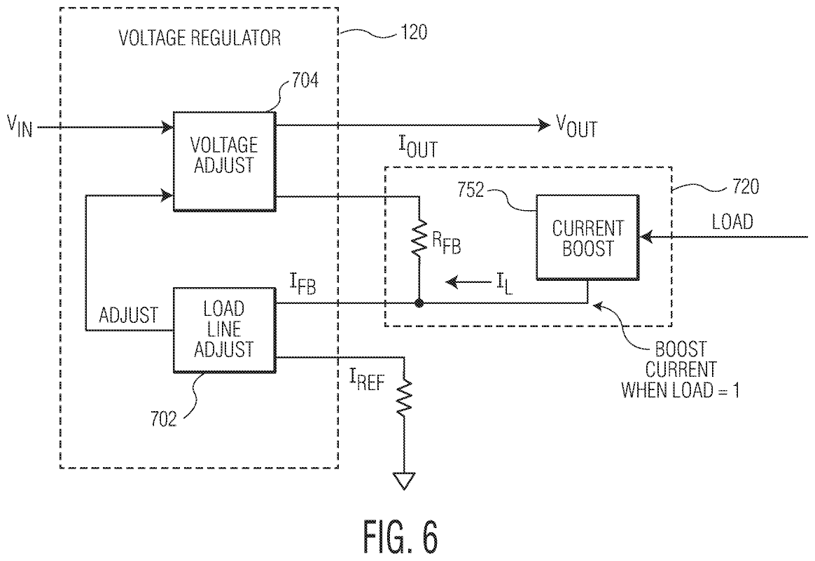

As another example of how the load signal may be used to adjust the input voltage of a regulator, FIG. 6 illustrates a feedback circuit 720 configured to vary a feedback current (I_{FB}) provided to a voltage regulator 120. As illustrated, the load signal may be used to control a current boost circuit 752. For example, the boost circuit 752 may be configured to generate an additional current I_{L} that is used to increase the feedback current I_{FB} when the load signal is asserted. In response, a load line adjust circuit 702 of the regulator 700 may generate a signal to a voltage adjust circuit 704 to increase the input voltage based on a comparison of the feedback current to a reference current (I_{REF}). When the load signal is not asserted, the additional current may be removed (I_{L}=0), causing a corresponding reduction in V_{IN}.

Those skilled in the art will recognize that various other types of feedback mechanisms may also be used and such mechanisms may be configured to allow the feedback signal provided thereby to be varied in any manner appropriate based on a load signal generated by a processor device.

As described above, a single bit load control signal may allow the voltage regulator to simply increase or decrease regulator input, while multiple bits may allow quantification of the additional current expected (e.g., 25 percent, 50 percent, etc.), allowing the anticipatory increases or decreases in voltage supplied by the regulator to be adjusted accordingly. In either case, the internal controls may include signal conditioning designed to receive the load control signal and generate the necessary type control signals (e.g., PWM phase signals) to cause the drive circuit to adjust the regulator input as accordingly.

In some cases, in an even greater degree of flexibility, a regulator(s) may be achieved by providing a scaling mechanism, wherein the magnitude of the changes in regulator input caused by the load control signal may be controlled. In other words, such scaling may allow the same regulator to be configured to increase/decrease the regulator input voltage over a relatively wide range, for example, from 1V to 20V, with the particular range selected depending on the needs of a particular application. This may provide an advantage from an inventory perspective, as a single such regulator may be stocked rather than multiple regulators. Further, increases in volume may also be achieved, which may lead to reduced cost.

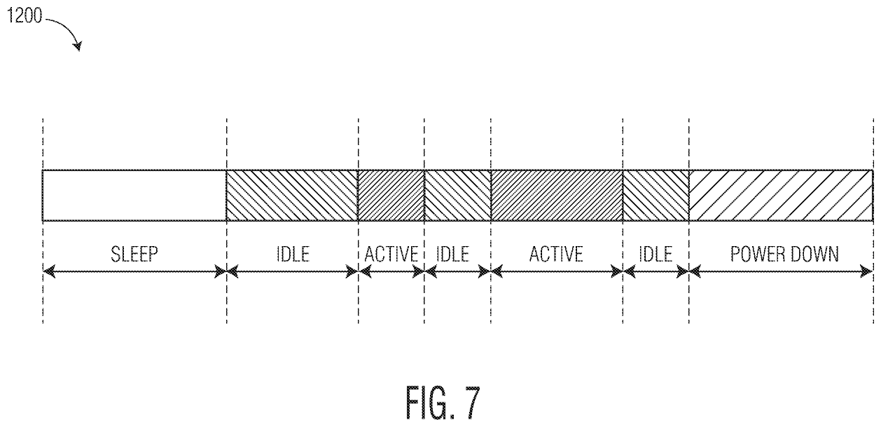

FIG. 7 shows an example 1200 of variation in loading state of a circuit section over time. As shown in FIG. 7, the dynamic loading state of a given circuit section may vary from time to time. In the example shown in FIG. 7, the loading state is either “active” or “idle” for the majority of time. However, the operating voltage may stay constant or otherwise unchanged. The loading state of the given circuit section may depend on the respective operational state (e.g., enabled or disabled) of each of the functional blocks in the given circuit section.

### EMBODIMENTS

### First Embodiment

In a first embodiment the invention provides for a power management system comprising a power supply device configured to provide a first input voltage and a second input voltage; at least one voltage regulator configured to receive the first and second input voltages and (i) provide a first output voltage, based on the first input voltage, to a first load, and (ii) a second output voltage, based on the second input voltage, to a second load; a power state indicator device configured to store data specifying (i) two or more power states for the first load including a first load current state defining a current power state of the first load and a first load next state defining a predicted, next-in-time, power state of the first load and (ii) two or more states for the second load including a second load current state defining a current power state of the second load and a second load next state defining a predicted, next-in-time, power state of the second load; and a power supply control device configure to independently vary (i) the first input and first output voltages based on a change from the first load current state to the first load next state and (ii) the second input and second output voltages based on a change from the second load current state to the second load next state.

In an embodiment according to the preceding embodiment, the power state indicator device uses a predictive signal.

In an embodiment according to the preceding embodiment, the predictive signal is used to enable and disable voltages, frequencies, gate drive, turn on and off load switches and alter switching frequencies of the voltage regulator to maintain ripple current.

In an embodiment according to the preceding embodiments, the predictive signal enables or disables both output and input voltages of the regulator and the power state indicator device.

In an embodiment according to the preceding embodiments, wherein the number of regulators comprises from one to twenty.

In an embodiment according to the preceding embodiments, predictive signal changes MCU/MPU, motor drive, RFID, system sensors, cellular signals, DC/DC, AC/AC, or AC/DC regulators and the like. The RFID is a radio-frequency identification that uses electromagnetic fields to automatically identify and track tags attached to objects.

In an embodiment according to the preceding embodiments, wherein the input voltage values are dependent on whether the power management system shuts down.

In an embodiment according to the preceding embodiments, The power management system according to claim 1, wherein the input voltages range from about 1 volt to about 20 volts.

In an embodiment according to the preceding embodiments, wherein the input voltages range from about 4 volts to about 8 volts.

In an embodiment according to the preceding embodiments, wherein the power state indicator device is a central processing unit (CPU).

### Second Embodiment

In a second embodiment the invention provides for a method of controlling an input voltage provided to a processing device that includes multiple processing pipelines by a voltage regulator, comprising: receiving, by the voltage regulator, a feedback enable or disable signal for controlling the input voltage of the voltage regulator; receiving a load control signal indicating an anticipated change in load current required by the device; and directly controlling a driver circuit of the voltage regulator used to generate the input voltage based on the load control signal by modifying the feedback error signal to provide an anticipatory change in the voltage to the device, whereby an absolute minimum voltage level is shifted up in anticipation of an increased load on the processing pipelines and an absolute maximum voltage level is shifted down in anticipation of an unloading of one or more of the multiple processing pipelines, thereby minimizing a total deviation of the input voltage from a nominal output voltage.

In an embodiment according to the preceding method embodiment, receiving the load control signal includes a scaling signal that is adjustable externally to the voltage regulator; and wherein the load control signal is conditioned based on the scaling signal.

In an embodiment according to the preceding method embodiments, wherein the scaling signal is adjustable via a plurality of external resistors placed in parallel and selectively utilized to modify the feedback error signal to provide the anticipatory voltage change.

In an embodiment according to the preceding method embodiments, wherein the scaling signal is adjustable via a writable register of the voltage regulator.

In an embodiment according to the preceding method embodiments, wherein the load control signal comprises a plurality of bits loaded into the writeable register.

In an embodiment according to the preceding method embodiments, wherein the load current is active when the input voltage is at a high distribution.

In an embodiment according to the preceding method embodiments, wherein the load current is idle when the input voltage is at a low distribution.

What is claimed is:

1. A power management system comprising:
a power supply device configured to provide a first input voltage and a second input voltage;
at least one voltage regulator configured to receive the first and second input voltages and (i) provide a first output voltage, based on the first input voltage, to a first load, and (ii) a second output voltage, based on the second input voltage, to a second load;
a power state indicator device configured to store data specifying (i) two or more power states for the first load including a first load current state defining a current power state of the first load and a first load next state defining a predicted, next-in-time, power state of the first load and (ii) two or more states for the second load including a second load current state defining a current power state of the second load and a second load next state defining a predicted, next-in-time, power state of the second load; and
a power supply control device configure to independently vary (i) the first input and first output voltages based on a change from the first load current state to the first load next state and (ii) the second input and second output voltages based on a change from the second load current state to the second load next state.

2. The power management system according to claim 1, wherein the power state indicator device uses a predictive signal.

3. The power management system according to claim 2, wherein the predictive signal is used to enable and disable voltages, frequencies, gate drive, turn on and off load switches and alter switching frequencies of the voltage regulator to maintain ripple current.

4. The power management system according to claim 2, wherein the predictive signal enables or disables both output and input voltages of the voltage regulator and the power state indicator device.

5. The power management system according to claim 1, wherein the number of voltage regulators comprises from one to twenty.

6. The power management system according to claim 2, wherein predictive signal changes MCU/MPU, motor drive, RFID, system sensors, cellular signals, DC/DC, AC/AC or AC/DC voltage regulators and the like.

7. The power management system according to claim 1, wherein the input voltage values are dependent on whether the power management system shuts down.

8. The power management system according to claim 1, wherein the input voltages range from about 1 volt to about 20 volts.

9. The power management system according to claim 1, wherein the input voltages range from about 4 volts to about 8 volts.

10. The power management system according to claim 1, wherein the power state indicator device is a central processing unit (CPU).

11. A method of controlling an input voltage provided to a processing device that includes multiple processing pipelines by a voltage regulator, comprising: receiving, by the voltage regulator, a feedback enable or disable signal for controlling the input voltage of the voltage regulator; receiving a load control signal indicating an anticipated change in load current required by the device; and directly controlling a driver circuit of the voltage regulator used to generate the input voltage based on the load control signal by modifying the feedback error signal to provide an anticipatory change in the voltage to the device, whereby an absolute minimum voltage level is shifted up in anticipation of an increased load on the processing pipelines and an absolute maximum voltage level is shifted down in anticipation of an unloading of one or more of the multiple processing pipelines, thereby minimizing a total deviation of the input voltage from a nominal output voltage.

12. The method of claim 11, further comprising: receiving the load control signal including a scaling signal that is adjustable externally to the voltage regulator; and wherein the load control signal is conditioned based on the scaling signal.

13. The method of claim 11, wherein the scaling signal is adjustable via a plurality of external resistors placed in parallel and selectively utilized to modify the feedback error signal to provide the anticipatory voltage change.

14. The method of claim 11, wherein the scaling signal is adjustable via a writable register of the voltage regulator.

15. The method of claim 11, wherein the load control signal comprises a plurality of bits loaded into the writeable register.

16. The method of claim 11, wherein the load current is active when the input voltage is at a high distribution.

17. The method of claim 11, wherein the load current is idle when the input voltage is at a low distribution.
